(19) United States
(12) Patent Application Publication
(10) Pub. No.: US 2012/0204537 A1
(43) Pub. Date: Aug. 16, 2012

(54) Adaptive diesel particulate filter regeneration control and method

(75) Inventors: Kevin Dea, Glinton (GB); Tom Carlill, Deeping St. James (GB); Oliver Cates, Birmingham (GB); Trent Chellingworth, Peterborough (GB)

(73) Assignee: CATERPILLAR INC., Peoria, IL (US)

(21) Appl. No.: 13/025,721

(22) Filed: Feb. 11, 2011

(51) Int. Cl. F02B 27/04; F01N 9/00; F01N 11/00

(52) U.S. Cl. 60/273; 60/277; 60/287

(57) ABSTRACT

An after-treatment device that includes a diesel particulate filter (DPF) requiring periodic regeneration includes a sensor providing a signal indicative of a soot accumulation and at least one device providing an operating parameter indicative of a work mode of the machine. A controller determines a soot loading of the DPF based least partially on the soot signal, and a readiness level based on the operating parameter. A soot level trigger is determined based on a time period since a regeneration was completed and the readiness level, and a debounce time period is determined based on the soot loading and the readiness level. The controller is configured to initiate a regeneration event of the DPF when the debounce time period has expired while the soot loading exceeds the soot level trigger.

### TECHNICAL FIELD

The present disclosure relates to a particulate trap regeneration system and, more particularly, to a particulate trap regeneration system and an associated control strategy.

### BACKGROUND

One of the byproducts of fuel combustion in an internal combustion engine is carbon particles, which are typically referred to as soot. Emission standards will typically specify a limit to the amount of soot that an engine can emit to the environment, which limit will be below the level of soot generated by the engine during operation. Therefore, various components and systems are employed by engine or vehicle manufacturers that control and limit the amount of soot emitted to the environment.

The time and duration of a regeneration event depends on many factors, such as the extent of accumulation of soot or carbon particulate matter on the filter, the operating conditions of the engine, and so forth. One example of a particulate trap system and control method therefor can be seen in U.S. Pat. No. 7,406,822 (hereafter, the '822 patent), which issued to Funke et al. and is assigned Caterpillar Inc. of Peoria, Ill. The '822 patent describes a system that includes a particulate trap and a regeneration device configured to reduce an amount of particulate matter in the particulate trap.

The system described in the '822 patent further includes a controller that activates the regeneration device in response to the first to occur of at least three trigger conditions. The trigger conditions may include, for example, operation of the engine for a predetermined period, consumption of a predetermined amount of fuel by the engine, detection of an elevated backpressure upstream of the particulate trap, detection of a pressure differential across the particulate trap that exceeds a threshold, or a calculated amount of particulate matter accumulated on the particulate trap that exceeds a limit. Such parameters may be independently evaluated to determine that a regeneration event is required. Thereafter, the controller may activate the regeneration device to oxidize the particulate matter found at the particulate trap.

Even though activation of a regeneration event for a particulate trap, whether such event involves use of a regeneration device or not, can be effective in removing trapped particulate matter when such concentration on a trap has exceeded a limit. Such regeneration may occur at any time during operation of the engine and may reduce, even temporarily, the effectiveness of any machine or vehicle, which heretofore has been an undesirable but necessary process. For example, a particulate trap installed on an on-highway truck may require the truck to be stopped on the side of the road while a regeneration event is taking place. It is desired to reduce or eliminate such intrusions to the normal operation of a vehicle or machine whenever possible.

### SUMMARY

The disclosure describes, in one aspect, a machine having an exhaust-treatment system that includes a diesel particulate filter (DPF) requiring periodic regeneration. The DPF is disposed to receive a flow of exhaust gas provided by an engine associated with the machine. The machine includes a sensor providing a soot signal indicative of a soot accumulation in the DPF, at least one device providing an operating parameter indicative of a work mode of the machine, and a controller associated with the machine and disposed to receive the soot signal from the sensor and the operating parameter from the at least one device. The controller is configured to determine a soot loading of the DPF based at least partially on the soot signal, determine a readiness level based at least partially on the operating parameter, determine a soot level trigger based on a time period since a regeneration was completed and the readiness level, and determine a debounce time period based on the soot loading and the readiness level. The controller is further configured to initiate a regeneration event of the DPF when the debounce time period has expired while the soot loading exceeds the soot level trigger.

In another aspect, the disclosure describes a method for initiating a regeneration event for a diesel particulate filter (DPF) associated with a machine. The DPF is disposed to receive a flow of exhaust gas from an engine of the machine. The machine includes a controller configured to selectively initiate a regeneration event of the DPF. The method includes determining a soot loading of the DPF based at least partially on the soot signal, determining a readiness level based at least partially on the operating parameter, determine a soot level trigger based on a time period since a regeneration was completed and the readiness level, and determining a debounce time period based on the soot loading and the readiness level. The controller is configured to initiate a regeneration event of the DPF when the debounce time period has expired while the soot loading exceeds the soot level trigger.

In yet another aspect, the disclosure describes an after-treatment system associated with an engine of a machine, which includes an after-treatment device disposed in fluid communication with an exhaust conduit that is connected to the engine, a regeneration device disposed along the exhaust conduit between the engine and the after-treatment device, a first sensor associated with the after-treatment device and disposed to provide a soot signal indicative of a soot accumulation in the after-treatment device, a second sensor associated with the machine and disposed to provide a work signal indicative of a work mode of the machine, and a controller associated with the engine, the regeneration device, the first sensor, and the second sensor. The controller includes at least one programmable processing unit and is disposed to determine a soot loading of the DPF based at least partially on the soot signal, determine a readiness level based at least partially on the operating parameter, determine a soot level trigger based on a time period since a regeneration was completed and the readiness level, and determine a debounce time period based on the soot loading and the readiness level. The controller is configured to command the regeneration device to initiate the regeneration event in the after-treatment device when the debounce time period has expired while the soot loading exceeds the soot level trigger.

### BRIEF DESCRIPTION OF THE DRAWINGS

FIG. 1 is an outline view from the side of a machine in accordance with the disclosure.

FIG. 2 is a block diagram of an engine having an after-treatment system associated therewith in accordance with the disclosure.

FIG. 3 is a block diagram of an after-treatment control in accordance with the disclosure.

FIG. 4 is a block diagram of a process for determining a soot level in a DPF in accordance with the disclosure.

FIG. 5 is a block diagram of a process for determining an application readiness level for regeneration of a DPF in accordance with the disclosure.

FIG. 6 is a block diagram of a regeneration control in accordance with the disclosure.

FIG. 7 is a block diagram of a DPF soot trigger calculator in accordance with the disclosure.

FIG. 8 is a block diagram of an adaptive soot level determinator in accordance with the disclosure.

FIG. 9 is a block diagram of a high speed regeneration (HSR) monitor in accordance with the disclosure.

FIG. 10 is a block diagram of a HSR condition check in accordance with the disclosure.

### DETAILED DESCRIPTION

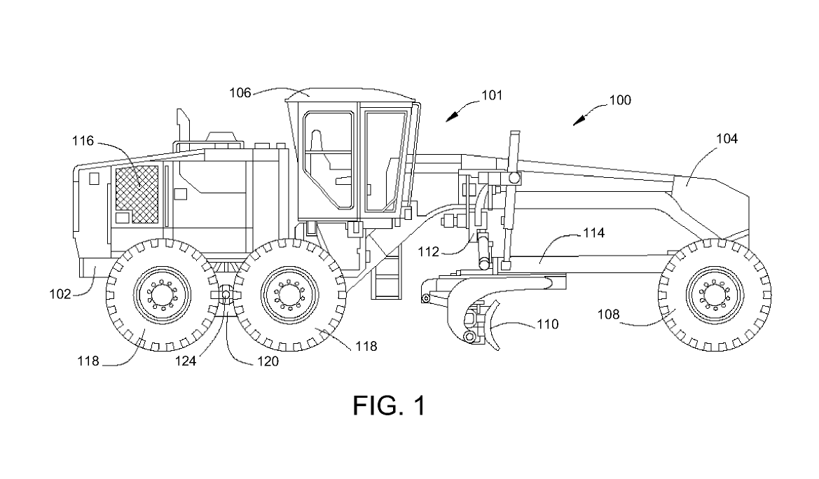

A side view of a machine 100, in this example a motor grader 101, is shown in FIG. 1. The term “machine” is used generically to describe any stationary or mobile machine. As can be appreciated, other machines may have different configurations and/or various other implements associated therewith than the machine illustrated in FIG. 1. The term “machine” as used herein may refer to any machine that performs some type of operation associated with an industry such as mining, construction, farming, transportation, or any other industry known in the art. For example, a machine may be an earth-moving machine, such as a wheel loader, excavator, dump truck, backhoe, motor grader, material handlers, pavers, locomotives, tunnel boring machines, or the like. Similarly, although an exemplary blade 110 is illustrated as the attached implement, an alternate implement may be included. Any implements may be utilized and employed for a variety of tasks, including, for example, loading, compacting, lifting, brushing, and include, for example, buckets, compactors, forked lifting devices, brushes, grapples, cutters, shears, blades, breakers/hammers, augers, and others. In the illustrated embodiment, mobile machines driven by use of electrical or hydrostatic power, by a gear system or transmission interconnecting drive wheels or other drive members with an engine, or any other known drive arrangement are contemplated. However, the methods and systems disclosed herein are applicable for any type of machine application, mobile or otherwise. For instance, an alternative embodiment for the machine 100 may include a stationary generator, an engine driven compressor, or another device capable of producing an alternative form of energy.

The motor grader 101 shown in FIG. 1 is illustrated as one example solely for purpose of discussion, and generally includes a two-piece frame made up of an engine frame 102 and an implement portion 104. Alternatively, the motor grader 101 may include a single frame piece. The engine frame 102 in the embodiment shown is connected to the implement portion 104 by a pivot (not shown). The implement portion 104 includes an operator cab 106 and two idle wheels 108 (only one visible) that contact the ground. A shovel or blade 110 is suspended along a mid-portion of the implement portion 104. The blade 110 can be selectively adjusted to engage the ground at various heights and angles to achieve a desired grade or contour while the motor grader 101 operates. Adjustment of the position of the blade 110 is accomplished by a system of actuators, generally denoted in FIG. 1 as 112, while support for the loading experienced by the blade 110 during operation is accomplished by a bar 114, which pivotally connects the implement portion 104 to the blade 110. The engine frame 102 supports an engine (not visible), which is protected from the elements by an engine cover 116. The engine provides the power necessary to propel the motor grader 101 as well as to operate the various actuators and systems of the motor grader 101. In the illustrated machine, the engine in the engine frame 102 may be associated with a hydrostatic pump (not shown), which may be part of a hydraulic system operating a propel system of the motor grader 101. In the embodiment shown, the motor grader 101 is driven by two sets of drive wheels 118 (only one set visible), with each set including two wheels 118 that are arranged in a tandem configuration along a beam 120, which is connected to the frame 102 at a pivot joint or bearing 122.

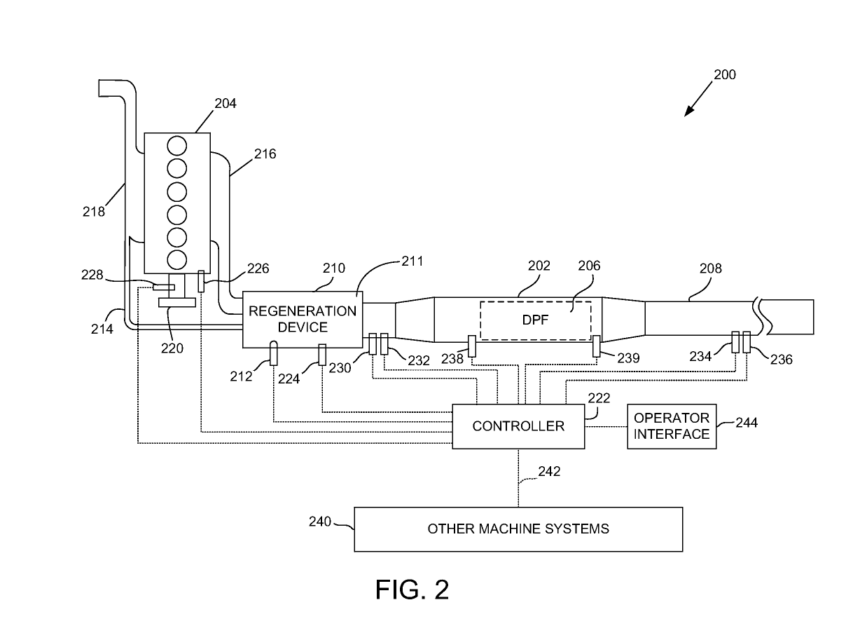

A block diagram of an after-treatment system 200 that may be associated with the machine 100 is shown in FIG. 2. The after-treatment system 200 includes an after-treatment device 202 disposed to receive a flow of exhaust gas from an engine 204. The after-treatment device 202 may additionally include one or more internal devices operating to chemically, or physically treat a flow of exhaust gas passing therethrough. Examples of such devices include oxidation catalysts, particulate filters, adsorbing filters, and others. Relevant to the present disclosure, the after-treatment device 202 essentially includes a diesel particulate filter (DPF) 206, which is shown in dashed line and which may be included as part of the after-treatment device 202 or may be disposed as a stand-alone part in fluid communication with an exhaust pipe or conduit of an engine.

The illustration of FIG. 2 will now be described in more detail. Such illustration is exemplary and represents one potential embodiment of an after-treatment system associated with an engine that is installed in a vehicle or machine. The after-treatment system 200 includes an exhaust conduit or pipe 208 that is fluidly connected to the after-treatment device 202 and DPF 206. Exhaust gas passing through the after-treatment device 202 and the DPF 206 flows through the exhaust pipe 208.

The DPF 206 is a device commonly used to limit the amount of soot expelled into the environment from an engine. In general, the DPF 2-6 includes a porous substrate, for example, made of ceramic material, that may be coated with various chemical compounds that alter the composition of exhaust constituents. The porosity of the substrate acts as a filter for physically trapping carbon particles or soot in an exhaust stream passing over and/or through the filter. One method of restoring the performance of the DPF 206 after it becomes saturated with soot is by a process called regeneration. In general, regeneration involves the oxidation or burning of accumulated particulate matter in the DPF. Such oxidation may include the introduction of a combustible agent, such as fuel, which is oxidized across a diesel oxidation catalyst (DOC) or otherwise combusted to create a temperature increase that oxidizes the particulate matter. Moreover, regeneration of DPFs often includes an elevation of the temperature of the particulate matter, for example, by elevating the temperature of the exhaust gas stream passing therethrough, prior to combustion.

Commonly used methods of regenerating the DPF involve an active intervention to the normal operation of the engine. Such intervention may be perceptible to an operator of the engine, and may even interfere with the normal operation of the vehicle. In other words, processes that alter the fueling strategy of an engine to introduce fuel in the exhaust stream or, more commonly, operation of the engine to increase exhaust temperature, such as by constricting the flow of exhaust or otherwise increasing the load output of the engine, increasing engine parasitic load, and others, can alter the behavior and power output of a vehicle or machine. Such alterations may interfere with normal use of equipment, which can have repercussions in the uptime and cost of operating the equipment.

In the embodiment shown in FIG. 2, the after-treatment device 202 is fluidly connected to a regeneration device 210. The regeneration device 210 may be any device operating to initiate, maintain, and/or control the rate of a regeneration event occurring in the DPF 206 during operation of the engine 204. One example of a regeneration device is described in the ‘822 patent discussed above. An additional example for a regeneration device 210 includes a burner 211disposed to selectively yield a flame that can be used to initiate, maintain, and/or control regeneration of particulate matter that has accumulated on the DPF 206. The illustrated regeneration device 210 includes an injector 212 disposed to inject a fuel, such as diesel, or a catalyst, for example, urea as is used in selective catalytic reduction (SCR) systems. When fuel is injected in engines having means to compress intake air, such as turbochargers or superchargers (not shown), a flow of fresh, compressed air can supplied via a conduit 214 to mix with the fuel and, in the presence of a spark, create the flame that introduces heat to the flow of exhaust gas and/or the DPF 206, but other methods can be used. Heat generated by the regeneration device 210, or otherwise provided by the engine, helps oxidize carbon and other deposits found on the DPF 206 during a regeneration event.

In the illustrated embodiment, the after-treatment device 202 is fluidly connected to an exhaust manifold 216 of the engine 204. The engine 204 operates to combine fuel and air supplied to a plurality of cylinders via an intake manifold 218 to produce power or torque at an output shaft 220. In a known configuration, each of the cylinders of the engine 204 includes a piston connected to a rotating crankshaft (not shown) via linkages (not shown). The reciprocating motion of the pistons generates a rotational motion of the crankshaft. Such rotational motion may be transferred to various components and systems of a machine, such as hydrostatic pumps, mechanical and/or hydraulic transmissions, electrical generators, work implements, and so forth. In the illustration of FIG. 2, the output shaft 220 generically represents a mechanical linkage that can transfer torque and power generated by the engine 204 during operation to any such components and systems of the machine.

The after-treatment system 200 may further include a controller 222. The controller 222 may be a single controller or may include more than one controller disposed to control various functions and/or features of a machine. For example, a master controller, used to control the overall operation and function of the machine, may be cooperatively implemented with a motor or engine controller, used to control the engine 204. The term “controller” broadly encompasses one, two, or more controllers that may be associated with the machine 100 and that may cooperate in controlling various functions and operations of the machine 100 (FIG. 1) including control of a regeneration device or regeneration processes. The functionality of the controller, while shown conceptually in the figures that follow to include various discrete functions for illustrative purposes only, may be implemented in hardware and/or software without regard to the discrete functionality shown. Accordingly, various interfaces of the controller are described relative to components of the after-treatment system 200 shown in the block diagram of FIG. 2. Such interfaces are not intended to limit the type and number of components that are connected, nor the number of controllers that are described. The interconnections between the controller 222 and the various sensors and actuators are denoted in dashed line, which represent communication lines for transferring information signals and commands to and from the controller 222. As can be appreciated, any appropriate type of connection may be used, for example, electrical conductors carrying analog or digital electrical signals, and/or electronic communication channels such as those found in controller area network (CAN) arrangements.

The controller 222 is connected to various sensors and actuators that are disposed to measure various parameters during operation of the after-treatment system 200. The controller 222 is thus disposed to receive information indicative of such operational parameters, to process such information, and to use such information to operate the after-treatment system 200 effectively and efficiently. As illustrated in the embodiment of FIG. 2, the controller 222 may be connected to the injector 212 and to a flame or temperature sensor 224 associated with the optional regeneration device 210. The controller 222 further maybe further connected to an engine speed sensor 226 and to an optional load sensor 228 disposed to measure a load being present at the output shaft 220.

The controller 222 also may communicate with an upstream temperature sensor 230 and an upstream pressure sensor 232. The upstream sensors 230 and 232 are disposed to provide signals to the controller 222 that are indicative of, respectively, the temperature and pressure of the exhaust gas flow before such flow enters or passes through the after-treatment device 202 and, in this case, before it passes through the DPF 206. The controller 222 may further communicate with a downstream temperature sensor 234 and a downstream pressure sensor 236. The downstream sensors 234 and 236 provide signals to the controller 222 that are indicative of, respectively, the temperature and pressure of the exhaust flow exiting the DPF 206. Even though separate sensors are shown disposed upstream and downstream of the DPF 206, for example, the upstream pressure sensor 232 and the downstream pressure sensor 234, one can appreciate that a single sensor may be used instead, for example, a differential pressure sensor disposed to measure a difference in pressure between upstream and downstream locations relative to the direction of flow of exhaust gas through the after-treatment device 202.

In one embodiment, the DPF 206 includes a soot sensor 238. The soot sensor 238, if present, operates to provide a signal that is indicative of the amount of material that has accumulated in the DPF 206. In one embodiment, the soot sensor 238 emits radio frequency signals that pass through a filter element of the DPF 206 before being received at a receiver 239. The soot sensor 238 and receiver 239 can be disposed on either side of a DPF filter sensing area and together provide a signal that is indicative of changes in amplitude between radio signals sent through the sensing area of the DPF 206, which may encompass the entire DPF 206 or a representative portion thereof. In one embodiment, such changes in amplitude are correlated to an extent of soot loading of the DPF 206, such that an estimation of the amount of material having collected within the DPF 206 can be determined by, for example, logic integrated in the soot sensor 238 and receiver 239. logic present within the controller 222, logic integrated within a dedicated controller (not shown), or the like.

In the embodiment of FIG. 2, the controller 222 is further connected to other machine systems 240, which are represented collectively as a single block in FIG. 2. Communication of information and command signals between the controller 222 and the other machine systems can be accomplished by any appropriate method. In one embodiment, a multi-channel CAN link 242 provides appropriate channels of communication between the controller 222 and each of the other machine systems 240. Such other machine systems can include any component or system of the machine that provides functional information during operation of the machine. Examples of such systems include a neutral switch, which provides information about a transmission or traction system of the machine, a parking brake switch, which provides information about the engagement state of a parking and/or emergency brake, a throttle setting switch, which provides information indicative of the extent of throttle engagement of the engine 204, an implement lockout engagement switch, an operator presence switch, and others. One can appreciate that different systems, and thus different information about such systems, may be available depending on the type of machine or vehicle involved.

An operator interface 244 is communicatively connected to the controller 222 and arranged to provide visual and/or audio information signals to an operator of the machine. Of course, such interface is optional and may include one or more operator controls, such as a manual enable or disable switch. The operator interface 244 may include a display for displaying information relative to the operational status of the after-treatment system 200. The operator interface 244 may be a standalone or dedicated interface for displaying information and receiving commands relative to the after-treatment system 200 alone, for example, when such system is retrofitted to an existing machine, or may be integrated with a multi-functional or multi-purpose display that is arranged to interface with other systems of the machine.

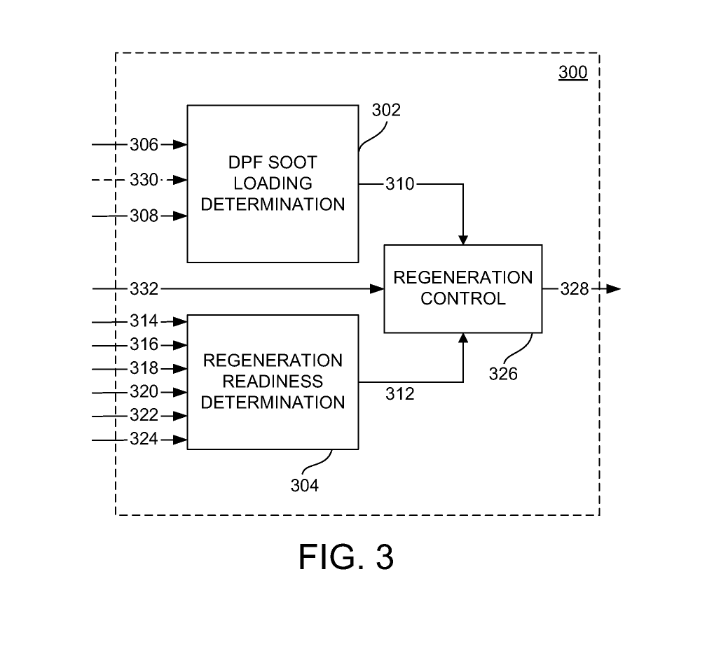

A block diagram of an after-treatment control 300 is shown in FIG. 3. The functions may be implemented partially or entirely within controller 222. The after-treatment control 300 is arranged to, essentially, perform two functions; a first function is to determine the soot loading of the DPF 206 (FIG. 2), which is illustrated as a DPF soot loading determinator 302, and the second is to determine a readiness state for performing a regeneration of the DPF 206, which is illustrated as a regeneration readiness determinator 304. During operation, the soot load is considered when deciding whether a regeneration event should be initiated based on the determination of the regeneration readiness of the system. In one embodiment, the after-treatment control 300 is arranged to initiate regeneration more aggressively when the soot loading of the DPF 206 is increased. The operation of one embodiment of the after-treatment control 300 will now be described in more detail.

In the embodiment illustrated in FIG. 3, the DPF soot loading determinator 302 operates to quantify, for example, as a percentage of full loading, the loading state of a DPF that is associated with an after-treatment system installed on a machine, such as the DPF 206 installed as part of the after-treatment system 200 of the machine 100 shown in FIG. 1 and FIG. 2. The DPF soot loading determinator 302 makes such determination based on a soot signal 306 and/or a pressure signal 308. The soot signal 306 may be provided by an appropriate sensor that is associated with the DPF 206, such as the soot sensor 238 and receiver 209 (FIG. 2), and the pressure signal 308 may be provided from a pressure sensor measuring exhaust gas pressure either upstream, downstream, or a pressure difference across the DPF. In one embodiment, such pressure sensor may be the upstream pressure sensor 232 (FIG. 2). In an alternate embodiment, the pressure sensor may be the downstream pressure sensor 234, a differential pressure sensor measuring a pressure difference across the DPF 206 (FIG. 2), or both the upstream and downstream pressure sensors 232 and 234, in which case a signal processing device may calculate the difference in value between the two sensors to yield the pressure signal 308.

The DPF soot loading determinator 302 provides a soot loading determination signal 310 as an output thereof. The soot loading determination signal 310 may be expressed in any suitable quantification parameter. In the illustrated embodiment, the soot loading determination signal 310 is expressed as a “Soot Load,” which is a positive value indicative of the grams of soot per liter volume of the filter element ranging from 0 to 5 and which depends on the percentage of soot loading having been determined for the DPF 206 according to Table 1, shown below:

TABLE 1

| | DPF Soot Loading (%) | | | | | | |
|---|---|---|---|---|---|---|---|
| | 0 | 50 | 80 | 100 | 110 | 120 | 140 |
| Soot Load (gr/L) | 0 | 1 | 2 | 3 | 3.5 | 4 | 5 |

As can be appreciated, the extent of soot loading in the particulate filter can be expressed as a percentage of the total capacity of soot that can be filtered by the filter element of the DPF 206, with percentage values that exceed 100% indicating that the DPF 206 has been overloaded.

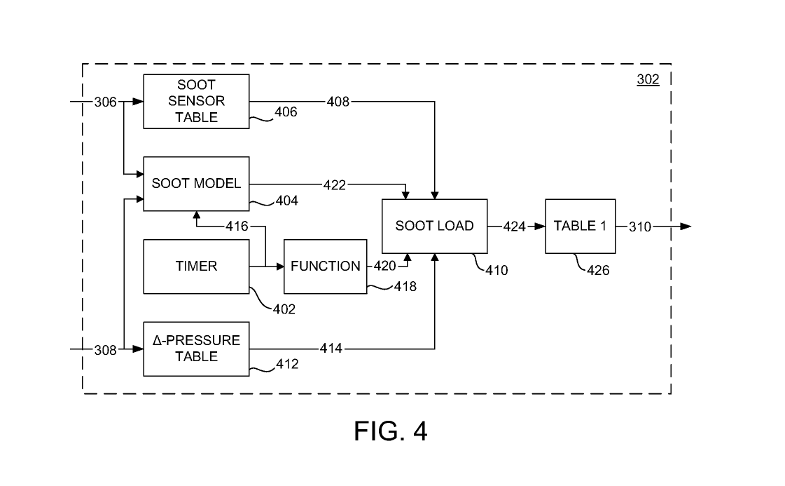

One embodiment of the DPF soot loading determinator 302 is shown in the block diagram of FIG. 4. In this embodiment, an implementation using multiple methods of determining the soot loading of the DPF 206 (FIG. 2) are operated in concert, but one can appreciate that any one of these, or other, equivalent methods, may be used. In the illustrated embodiment, the DPF soot loading determinator 302 employs four different methods of estimating the soot loading of a DPF filter, which methods include an estimation based on the soot signal 306, the pressure signal 308, a timer 402, and a soot accumulation model 404.

Beginning with the determination based on the soot signal 306, the soot signal 306 is provided to a transfer function, which is illustrated as a soot sensor table 406. Information about the soot loading state of the DPF is provided by the soot signal 306 in the form of, for example, a voltage, which is then correlated to a value representing the actual soot loading of the DPF 206. The values populating the table 406 may be predetermined as a result of a calibration of the sensor providing the soot signal 306, and can be provided as a sensor-based soot signal 408 to a soot load selector 410.

In a similar fashion, the pressure signal 308 can be provided to a pressure difference table 412, which provides a pressure-based soot signal 414 to the soot load selector 410. The pressure difference table 412 may be calibrated to correlate values of pressure difference across a DPF to estimations of the corresponding soot loading of the DPF. In the case where a pressure value upstream or downstream of the DPF is used, for example, as indicated by signals from upstream and/or downstream pressure sensors 232 and 234, instead of a pressure difference across the DPF, the pressure table 412 may be calibrated accordingly.

In a third method of calculating soot loading on a DPF, the soot signal 306 and/or the pressure signal 308 may be provided to the soot accumulation model 404. In one embodiment, both the soot signal 306 and pressure signal 308 are provided to the soot accumulation model 404, but in alternate embodiments that include model-based soot accumulation calculators fewer, different, or no such signals may be provided. In the illustrated embodiment, a time signal 416 generated by the timer 402 is also provided to the soot accumulation model 404. The time signal 416 may simply be indicative of the operating time of the engine since a previous or last regeneration event, or may alternatively be indicative of another operating parameter of the engine since the last regeneration event. Such other operating parameters of the engine may include total hours of operation, total amount of fuel used, total amount of power generated, and others, all calculated since a last regeneration event of the engine. One can appreciate that any parameter of the operation of the engine that is correlated to the amount of carbon produced by the engine may be tracked and its effect on carbon deposition quantified during intervals between regeneration of the DPF.

The time signal 416 is also provided to a time function 418 in one embodiment. The time function 418 may be a control device that correlates an estimated time-based soot signal 420 with, in this case, the time signal 416. As in the other modes, the time-based soot signal 420 is provided to the soot load selector 410.

In the illustrated embodiment, the soot accumulation model 404 may be an analytical or empirical function or model that estimates the soot accumulation on a DPF based on operating parameters of an engine, in this case, a signal from a soot accumulation sensor, an indication of a pressure across the DPF, and a time since the last regeneration was performed. The output of the soot accumulation model 404 is a model-based soot signal 422 that is provided to the soot load selector 410.

The soot load selector 410 provides an estimated soot loading 424 to a table 426, such as Table 1. The estimated soot loading 424 may be determined based on one or more of the various signals provided to the soot load selector 410. In one embodiment, the soot load selector 410 may simply select the highest estimated value of soot loading among the signals provided, namely, the sensor-based soot signal 408, the model-based soot signal 422, the time-based soot signal 420, and the pressure-based soot signal 414. In such embodiment, selection of the highest estimation for soot loading ensures that the estimation of the soot loading will be conservative.

In an alternate embodiment, the soot load selector 410 may determine the best estimation of soot loading based on the signals provided. More specifically, the soot load selector 410 may monitor the soot signals provided to ensure that any estimation is both accurate and consistent with the efficient operation of the engine. The soot load selector 410 further may consider the sensor-based soot signal 408 as the base for estimating the soot accumulation of the filter. The soot accumulation thus estimated may be compared with the model-based soot signal 422 to ensure that it is consistent or within an acceptable range, for example, a range of ±10%. This comparison may be performed as a check of the values provided by the sensor providing the soot signal.

An additional check of the sensor-based soot signal 408 may be made by comparing the time-based soot signal 420 and/or the pressure-based soot signal 414 with the sensor-based soot signal 408. As before, such comparison may be used to discover potential issues with the accuracy of the soot signal 306 when the result of the comparison indicates a discrepancy between the compared values of more than a threshold value, for example, a discrepancy of about 10% or more.

The estimated soot loading 424 is provided to the table 426, which yields the normalized soot level or soot loading determination signal 310 (FIG. 3). In one embodiment, the estimated soot loading 424 is expressed in terms of percentage of the soot loading capacity of the DPF. The soot loading determination signal 310 is determined based on a lookup table, for example, Table 1 described above.

Returning now to FIG. 3, the after-treatment control 300 further includes the regeneration readiness determinator 304, which provides a readiness level signal 312 based on one or more signals that are indicative of the state or work-mode of the machine. The regeneration readiness determinator 304 examines the functional state of various machine components or systems for indications of ongoing or imminent changes in operational status. The regeneration readiness determinator 304 provides an indication, in the form of the readiness level signal 312, of the state of machine operation. The readiness level signal 312 can provide multiple levels of the work status of the machine ranging from the machine being completely idle or not in a work mode to the machine being fully engaged at work. Such information may be used to determine when a regeneration event may be initiated.

As can be appreciated, a non-work mode of the machine is the desired time to initiate regeneration because a regeneration event may be intrusive to the machine's operation when the machine is in work mode. However, initiation of a regeneration may be conducted at other times should it become necessary due to high soot loading of the DPF. In other words, the importance of initiating a regeneration event may increase based on soot loading of the DPF and is balanced against the relative undesirability of initiating regeneration when the machine is working. In the embodiment presented, certain machine operating parameters are presented as inputs provided to the regeneration readiness determination, but any other parameters may be used. Further, different machines or vehicles may include components and systems that are better suited to provide an indication of the work mode of the machine or vehicle, and in such instances, the regeneration readiness determination may be tailored to make use of such specialized parameters. Examples of specialized parameters include guidance and navigation information of autonomously guided vehicles, and so forth. The embodiment described below refers to parameters that may be available on a work machine and should not be construed as exclusive of other parameters that may be used in addition to or instead of the parameters presented.

The regeneration readiness determinator 304 in the embodiment illustrated is provided with a park brake signal 314, a neutral transmission signal 316, an implement status signal 318, a throttle control signal 320, a throttle signal 322, a vehicle speed signal 324, and potentially others, such as a signal indicating that an operator is present, or fewer signals. Such signals are processed within the regeneration readiness determinator 304 to provide the readiness level signal 312. In one embodiment, the readiness level 312 is an integer value between 0 and 10, with 0 indicating that the machine is in full work mode and 10 indicating that the machine is not in work mode. Readiness levels between 1 and 7 indicate various intermediate states of work mode, with a level of 1 being a minimum level at which regeneration may be initiated. The readiness level 312 is generally indicative of the confidence or probability that the machine will remain in the determined readiness level for a sufficient period in which to initiate and complete a regeneration.

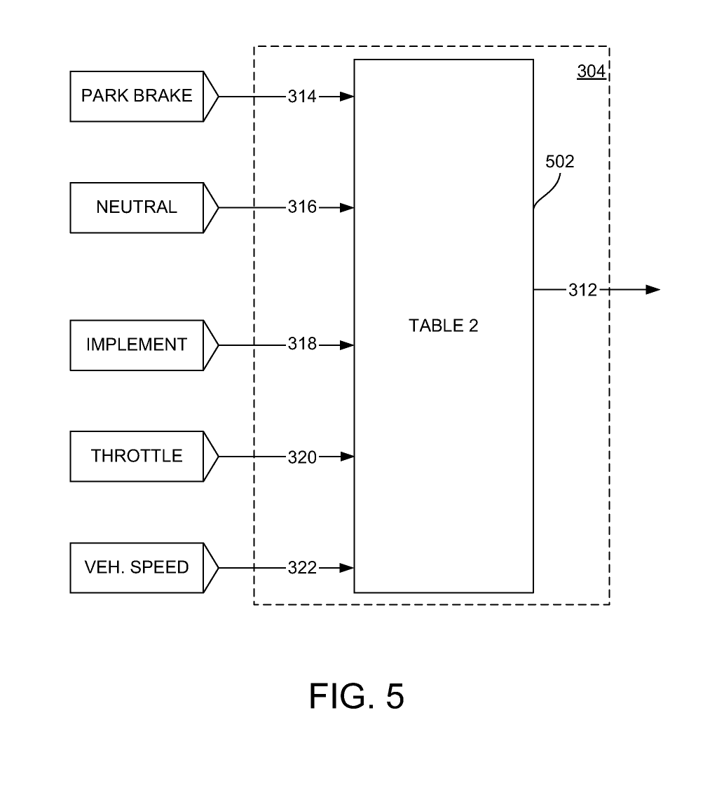

A block diagram of one embodiment for the regeneration readiness determinator 304 is shown in FIG. 5. In this embodiment, various machine operating parameters are provided to a table function 502 and used to determine the operating state of the machine. For example, the park brake signal 314 may be a simple ON/OFF indication of whether the parking or emergency brake of the machine has been set by the operator. Setting of the parking brake can be an indication of whether the machine is in work mode or not. The neutral transmission signal 316 is indicative of the gear selection in a transmission of a machine. The neutral transmission signal 316 may be a simple ON/OFF signal indicative of whether the transmission of a machine is in gear, which is an indication that the machine may be moving or preparing to move, or whether the transmission is in neutral. The implement status signal 318 may be a signal indicative of an activated implement status, or alternatively an interlock status of an implement control. The throttle control signal 320 may be an indication of whether a preset speed has been selected for the machine. The throttle signal 322 may be indicative of the extent of throttle activation of the machine, and the vehicle speed signal 324 may be indicative of the ground speed of the machine. One can appreciate that such signals may provide information as to the operating mode of the machine, but other parameters may be used, such as signals from an operator presence switch or sensor, a steering sensor, and so forth. Such and other signals may be provided to a table, for example, Table 2 (FIG. 5), for categorization of the relative readiness level 312 of the machine for regeneration of a machine based on the estimated work mode of the machine.

The various parameters provided to the regeneration readiness determinator 304 are evaluated and such information is categorized to determine the relative state of work mode. The categorization is tabulated against a range of readiness levels, which represent the relative level of work the machine is in at any time, including a determination that the machine is not in a work-mode. In general, the readiness level 312 serves as an indication of not only the work-mode of the machine, but also the level or confidence that the machine will remain at that work-mode for a sufficient time to conduct the regeneration.

Returning to FIG. 3, the soot loading determination signal 310 and the readiness level 312, as well as other machine and engine parameters 332, are provided to a regeneration control 326. The regeneration control 326 is arranged to schedule the initiation of a regeneration event based on the soot loading determination signal 310, the readiness level 312 and certain other machine and engine parameters 332. In general, the regeneration control 326 is configured to initiate a regeneration event of the DPF either during a work-mode of the machine or when the machine is in a non-work mode, such as between work modes. The decision to initiate regeneration may depend on various factors and parameters such that incomplete regenerations, i.e. regenerations that are initiated but not completed, are minimized. In this way, the regeneration control 326 is configured to determine which machine conditions are optimal to initiate a regeneration event as well as determine the appropriate regeneration parameters based on the readiness level 312.

The appropriate time for initiating a regeneration event further depends on the soot loading of the DPF. In one embodiment, the threshold level of soot loading that is appropriate for initiating regeneration (the soot trigger) is selected based on an adaptive function, which considers the number of regeneration opportunities over a period of machine working hours and the time period since the last regeneration was initiated, regardless of whether the last regeneration was initiated during a work-mode or non-work mode of the machine. In this embodiment, a work mode regeneration can be allowed to occur at a fixed soot level offset above the non-work mode regeneration trigger soot level such that priority is given to non-work mode regeneration.

Having determined the work-mode status and corresponding soot level threshold, an amount of time in which operational stability is confirmed before regeneration can be initiated, a parameter referred to as the debounce time in the description that follows, is determined. For non-work mode regenerations, appropriate selection of the debounce time helps avoid partial regenerations, i.e., regenerations that are terminated before they are completed because of a change in operating conditions of the machine. In one embodiment, the debounce time is determined based on soot loading in the DPF and the number of regeneration opportunities that existed prior to the present. In this way, a higher priority can be afforded to initiating a regeneration at a relatively higher soot loading when opportunities to initiate regeneration abound. The debounce time is also determined based on the work mode of the machine such that regeneration can be initiated faster when the regeneration readiness level of the machine is high, for example, at a level 4 or below.

When regeneration is to be conducted during a work mode, semi- or quasi-steady state work conditions are selected for regeneration. In this way, the transient nature of the particular machine application can be analyzed such that regenerations are initiated based on fixed time intervals in which machine operation has been and is expected to be in a quasi-steady state, which may generally refer to an operating condition of the machine during which certain parameters remain relatively constant or within a predetermined range of operating values, such as within 5 or 10% of a median value. Debounce times can also be determined on soot loading and on adaptive or learned service profiles of the machine. Additionally, the regeneration control may monitor the number of non-work mode regenerations that have occurred and disable the work-mode regeneration initiation functionality when a sufficient number of non-work mode regenerations have been completed. Various embodiments of a regeneration control configured to carry out at least some of the aforementioned functions is hereinafter described. In general, the regeneration control 326 operates to monitor the number of low speed regeneration (LSR) opportunities and, in one embodiment, further inhibit regenerations during a work-mode when the number of LSR opportunities exceeds a threshold number while the soot loading in the DPF remains below an upper threshold loading level.

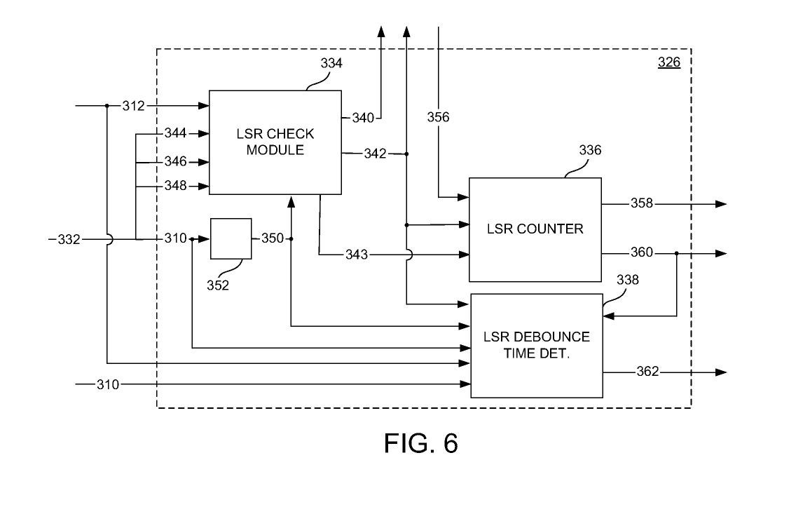

A first embodiment of the regeneration control 326 is shown in FIG. 6. In the illustrated embodiment, the regeneration control 326 is configured to automatically initiate a LSR. In the context of the embodiment shown in FIG. 6, “low speed” refers to a relatively low engine speed at which regeneration is initiated, which typically occurs when the machine is not in a work-mode. In the description that follows, LSR may also be used for a non-work mode regeneration regardless of engine speed. In the illustrated embodiment, the regeneration control 326 includes a LSR check module 334, which is configured to determine acceptable windows of regeneration initiation, a LSR Counter 336, which monitors the LSR opportunities, and a LSR debounce time determinator 338.

The LSR check module 334 is disposed to receive various signals during operation to provide a LSR readiness flag 340. The LSR readiness flag 340 may be a digital value of 0 when the system is not ready for regeneration and a value of 1 when the system is ready for regeneration. The LSR check module 334 further provides a LSR window indicator 342, which is indicative that conditions suitable for regeneration are present. A LSR debounce time signal 343 is also provided, which is indicative of a signal to initiate a debounce timer. Both the LSR readiness flag 340 and LSR window indicator 342 are shown as outputs of the regeneration control 326 because they may be provided to other systems, such as an engine control module, a regeneration device 210 (FIG. 2), and/or others.

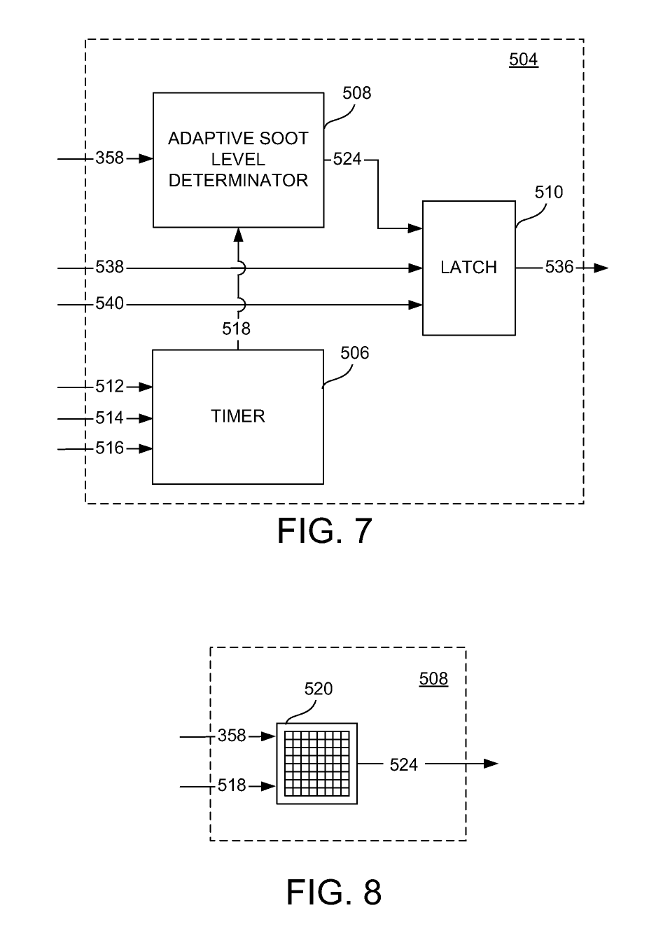

The LSR check module 334 is configured to receive various signals, such as the readiness level signal 312 and other machine and engine parameters 332, which can include engine speed 344, engine fueling rate 346 and an automatic regeneration desired (ARD) signal 348. The ARD signal is optional and indicative of the a regeneration currently underway in the machine. The LSR check module 334 further receives a DPF regeneration readiness signal 350. The DPF regeneration readiness signal 350 is provided by a function 352 based on a DPF soot loading or status signal 354. The readiness signal 350 is activated when the soot in the DPF exceeds a predetermined level, which in the illustrated embodiment is provided by the soot loading trigger 534, as shown in FIG. 7 and described in more detail relative to that figure.

During operation, the LSR check module 334 operates to check whether an appropriate window of engine or machine operation is present such that regeneration may be initiated when the machine is not in a work mode or is in a light work mode. Accordingly, the LSR check module 334 may compare the engine speed 344 and/or engine fueling rate 346 with predetermined minimum and maximum window thresholds to determine when the respective parameters are within the predetermined window. These comparisons may occur both to determine when the regeneration engine speed and load window is present as well as to determine when an opportunity to regenerate may have been present during operation even if a regeneration was not initiated, for example, when the machine is operating under a manual regeneration initiation mode. Accordingly, the LSR readiness flag 340 is activated when the engine is operating within a window of engine speed and load that are suitable for regeneration, while the LSR window indicator 342 is activated while the opportunity to regenerate automatically is present. Further, the LSR debounce time signal 343 can be activated when the LSR window indicator 342 and the DPF regeneration readiness signal 350 are active while a previous regeneration is not still ongoing.

The LSR debounce time signal 343 and LSR window indicator 342 are provided to the LSR counter 336, which is also configured to receive an engine lifetime signal 356 indicative of the total engine run time. The LSR counter 336 is configured to provide information indicative of the history of LSR regeneration opportunities, such as a LSR counter 358 and a LSR index 360, which may include timestamp and other particular information for each LSR opportunity carried out to a historical log (not shown) that can be used to schedule future regenerations. The LSR counter 336 may operate to monitor various parameters to determine the suitability of a LSR event and log such occurrences. The LSR index 360 represents a LSR event count, which may aggregate the number of LSR events occurring during a predetermined period of machine operation, for example, a predetermined span of hours.

The LSR index 360, DPF regeneration readiness signal 350, soot loading determination signal 310 (see FIG. 3), readiness level signal 312, and the LSR window indicator 342 are provided to the LSR debounce time determinator 338. Based on at least some of these parameters, the LSR debounce time determinator 338 of the illustrated embodiment is configured to determine and provide a LSR command signal 362, which is indicative that regeneration is allowed both in terms of machine and engine operating conditions as well as from the standpoint of permitted regeneration timing.

During operation, the LSR debounce time determinator 338 may monitor the various parameters to confirm that regeneration is desired and enabled, and the machine is operating within the predetermined window. When these conditions are all present, the LSR debounce time determinator 338 may determine an appropriate debounce time based on the readiness status, the soot loading of the DPF, the LSR count 358, and the debounce time signal 343. The determination of the debounce time may be accomplished by any appropriate method. In the illustrated embodiment, the LSR debounce time determinator 338 includes a lookup table or map that determines an appropriate debounce period based on the DPF soot loading determination signal 310 and the LSR opportunity counter. In this way, the debounce time, which represents a time period in which regeneration is not initiated to ensure that operating conditions are sufficiently stable, may be set lower (i.e. so regeneration may start sooner) when the DPF loading is high and when opportunities in which to regenerate do not occur often. Similarly, if ample opportunities to regenerate are present, the debounce time may be increased for higher DPF soot loads to ensure that sufficiently stable conditions are present to complete a regeneration initiated. When the debounce time signal 343, which can be in the form of a digital value, remains active for at least the debounce time period determined by the LSR debounce time determinator 338, the LSR command signal 362 can be provided.

Apart from the regeneration initiation conditions already described, the system of the present disclosure is further configured to adaptively adjust the soot loading trigger level for regeneration. The adaptive adjustment of the DPF soot trigger enables more economical and fuel efficient operation of a machine or vehicle because it is configured to, generally, initiate regeneration at relatively high soot loading levels when opportunities to regenerate are frequent and the likelihood that a regeneration will be initiated and completed is high.

One embodiment of an adaptive or learning DPF soot trigger calculator 504 is shown in FIG. 7. In this embodiment, the soot loading required to initiate a regeneration is adjusted by being offset based on various machine parameters including the time since the last regeneration, the number of opportunities for regeneration that have occurred, and the actual soot loading of the DPF.

In the illustrated embodiment, the DPF soot trigger calculator 504 includes a timer 506, an adaptive soot level determinator 508, and a latch 510. The timer 506 is configured to receive a time signal 512 indicative of a clock measurement since a previous regeneration was initiated, an engine run time signal 514, and a regeneration active flag 516, which is indicative of the initiation of a regeneration. The timer 506 is configured to calculate and provide a timer signal 518 indicative of a time period during engine operation since a last regeneration was initiated to the adaptive soot level determinator 508.

The adaptive soot level determinator 508 is disposed to receive the timer signal 518 as well as a regeneration counter signal indicative of the past opportunities to regenerate, for example, the LSR counter 358 (FIG. 6). Based on these or similar parameters, the adaptive soot level determinator 508 is configured to provide a soot loading threshold or trigger offset value that can be used as a threshold soot loading for initiating regeneration. The basis of this trigger on the number of past opportunities to regenerate and the time since a last regeneration is useful in tailoring the trigger level to a particular application in which, if opportunities to regenerate abound, the soot loading may be set higher than other applications in which opportunities to regenerate are fewer.

One embodiment for the soot level determinator 508 is shown in FIG. 8. In this embodiment, the adaptive soot level determinator 508 includes a lookup table 520 for interpolating desired soot loading offset values, which will act as trigger offset values 524 to initiate regeneration. The trigger offset values 524 are determined based on the LSR counter 358 and the time since the last regeneration, which is provided by the timer signal 518. During operation, the trigger offset value 524 is determined in real time and represents a desired offset from the corresponding LSR soot trigger value at which regeneration may be initiated. In other words, the offset values may tend to change the trigger level for a regeneration based on soot loading. Thus, the soot loading trigger may be decreased in the presence of few regeneration opportunities and a long time since a regeneration was performed. Similarly, the soot levels at which a regeneration is triggered can be increased when opportunities to regenerate abound and/or a regeneration was completed relatively recently.

Returning now to FIG. 7, the trigger offset value 524 is provided to latch 510. The latch 510 is configured to provide a regeneration trigger 536 that initiates a regeneration. Apart from the trigger offset value 534, the latch is further disposed to receive an automatic regeneration active status flag 538, which is indicative that a regeneration may currently be underway, and a regeneration completion status flag 540, which is indicative that a previously initiated regeneration has been completed. In this way, the regeneration trigger 536 may be activated when the actual soot loading of the DPF 206, as indicated by the soot loading determination signal 310, exceeds the acceptable offset trigger values, as previously discussed relative to FIG. 8, as long as a regeneration is not currently underway and a previous regeneration has been completed.

As previously discussed, the system disclosed is configured to determine whether the machine is in a work mode. As shown, for example, in FIG. 5, the readiness level signal 312 is indicative of the work state of the machine, which can be used by the LSR check module 334 to determine an appropriate non-work mode or light-work mode window of operation for regeneration. However, it is possible that certain machine applications may rarely operate within an acceptable operating window for LSR. For such machine applications, a regeneration during a high speed condition (high speed regeneration, or “HSR”) or, in other words, a regeneration occurring during a work mode of the machine, may be required.

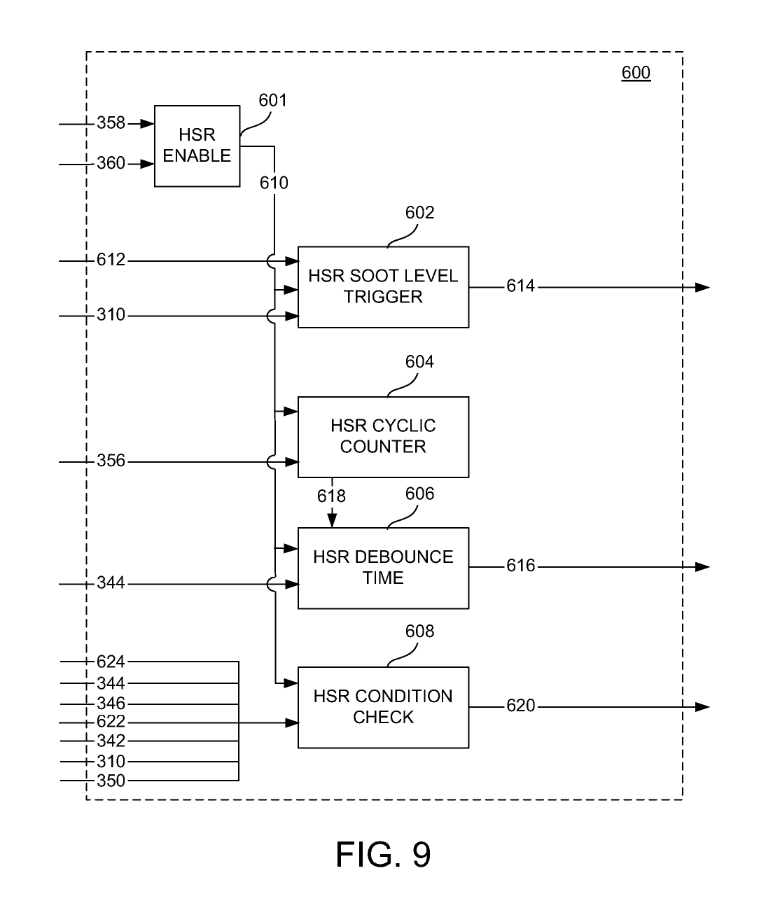

Accordingly, a HSR monitor 600 for initiating HSR when opportunities to perform a LSR are infrequently predicted to be present in the future is shown in FIG. 9. In the illustrated embodiment, the HSR monitor 600 includes various functions, such as a HSR enable strategy 601, a soot trigger level determinator 602, a HSR cyclic counter 604, a HSR debounce time calculator 606, and a HSR condition check 608. Each of these functions will now be described in more detail.

The HSR enable strategy 601 is configured to receive a signal indicative of the number of LSR events that have occurred, for example, the LSR counter 358 and/or the LSR index 360 (FIG. 6). While the occurrences of LSR opportunities are below a predetermined occurrence frequency, which can be determined by a map function based on the LSR counter 358 and/or the LSR index 360, the HSR enable strategy 601 may provide a HSR enable flag 610 that permits the initiation of a regeneration during a work mode of the machine, provided other HSR initiation criteria have been satisfied, such as an insufficient frequency of LSR opportunities being present or the soot loading of the DPF exceeding a maximum loading threshold.

The HSR monitor 600 further includes the HSR soot level trigger 602, which is configured to receive a signal indicative of the soot loading in the DPF, for example, the soot loading determination signal 310, and/or other parameters, such as a signal 612 that is indicative of the presence of an opportunity to regenerate during a work mode of the machine. The signal 612 may be determined by use of any appropriate methodology. In the illustrated embodiment, the signal 612 is a digital 1 or 0 value that is activated when operating conditions of the machine, even during a work mode, have been stable or within a predetermined range of values consistently for a predetermined time. The HSR soot level trigger 602 is configured to provide a HSR soot limit check 614, which represents an allowed offset for the LSR soot loading trigger 534 (FIG. 7). In one embodiment, the HSR soot limit check 614 represents a dynamically delimited value for the soot loading determination signal 310. The lower limit of the delimited value is calculated by setting a low threshold that is equal to the LSR soot trigger, and the upper limit may be set to a constant. In this way, the HSR soot level trigger 602 may always be within an acceptable range for purposes of initiation HSR events. In the illustrated embodiment, the HSR soot limit check 614 is configured be offset from the soot level value that initiates a LSR event by a predetermined and, in the illustrated embodiment, fixed, value.

As in the initiation of LSR events, the HSR monitor 600 further includes the HSR debounce time calculator 606, which determines an appropriate debounce time period. Similar to the LSR debounce time signal 343 (FIG. 6), the HSR debounce time calculator 606 provides a HSR debounce time signal 616, which represents the time delay in initiating a HSR event after conditions favorable for such an event have been present and remain favorable for regeneration.

During operation, the HSR debounce time calculator 606 may monitor various parameters to confirm that regeneration is desired and enabled, and the machine is operating within the predetermined window. When these conditions are all present, the HSR debounce time calculator 606 may determine an appropriate debounce time based on the readiness status, the soot loading of the DPF, and whether a LSR has been recently completed. The determination of the debounce time may be accomplished by any appropriate method. However, given that a HSR event may be conducted during a work-mode of the machine, during which machine operating parameters may not be sufficiently constant for prolonged periods, the HSR debounce time calculator 606 may include further functionality to determine whether the machine is operating in a relatively transient fashion such that the debounce time may be shortened appropriately to achieve initiation of a regeneration event even under such conditions when the DPF soot loading is high. In the illustrated embodiment, the HSR debounce time calculator 606 may monitor a machine parameter, for example, engine speed 344 (also see FIG. 6), a parameter related to engine speed or load, or a value derived from engine speed or load and the like.

The parameter monitored in this way may be compared to a predetermined threshold, such as a tabulated set of threshold values, to determine whether excessive variation is present. One example of a machine application duty cycle having excessive variability that may prevent the initiation of a regeneration event is one that has a square wave time trace of engine speed, such as may be present in an excavator machine during a loading operation. For such and other, similar conditions, the HSR debounce time calculator 606 may change the otherwise calculated debounce time to a predetermined, short debounce time value that will allow the regeneration to occur during the work mode despite a periodic variation in engine speed or load.

At times when HSR events are initiated, the HSR monitor 600 may optionally activate the HSR cyclic counter 604. This function, when present, works in conjunction with the HSR debounce time calculator 606 to provide an indication that a cyclic operating condition is present such that the HSR debounce time signal 616 may be switched to the short debounce time. The HSR cyclic counter 604, in one embodiment, is configured to receive the HSR enable flag 610, an engine lifetime signal 356 (FIG. 6), and/or other parameters. Based on these parameters, the HSR cyclic counter 604 may monitor how many times within a predetermined period, for example, 20 minutes, the HSR debounce time signal 616 has switched to the low debounce time, and provide a signal 618 to the HSR debounce time calculator 606 that adopts the short debounce time, at least temporarily, as the default debounce time value for HSR events.

The HSR cyclic counter 604 may further include the HSR condition check 608, which is configured to monitor machine operation and provide a HSR force allow signal 620 when certain enabling conditions for regeneration are present. In other words, although the LSR events may be preferred for reasons of improved fuel economy and the like, in the event the opportunities in which to conduct LSR are infrequent, the HSR condition check 608 may allow or even force a HSR regeneration to occur under the parameters previously described when certain conditions favorable for regeneration are present.

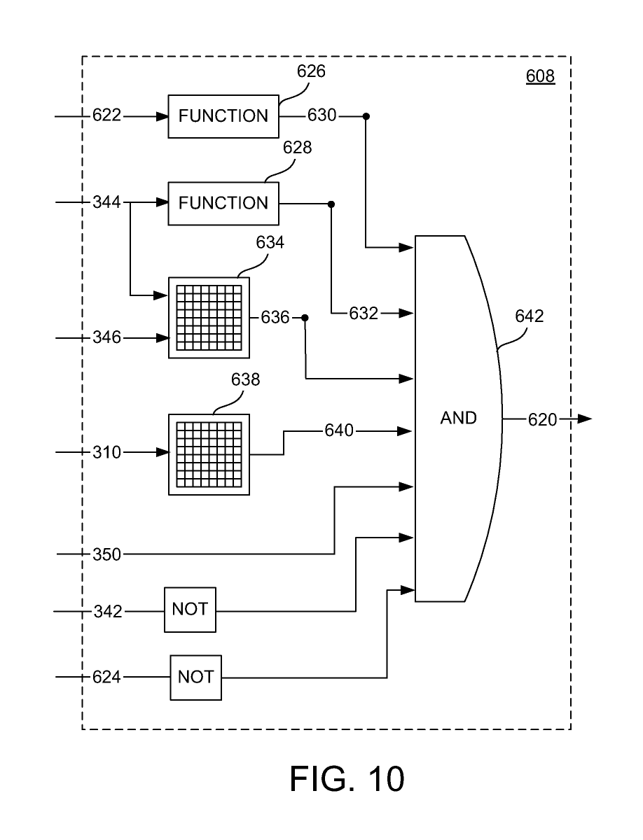

In the illustrated embodiment, the HSR condition check 608 is disposed to receive various input signals, including engine speed 344, engine fueling rate 346 or another indication of engine load, engine intake air pressure 622, LSR window indicator 342, soot loading determination signal 310, a regeneration active flag 624, the regeneration readiness signal 350, and others. A block diagram for one embodiment of the HSR condition check 608 is shown in FIG. 10.

As illustrated in FIG. 10, the HSR condition check 608 includes two functions 626 and 628 that are configured to detect transient or step changes in, respectively, the intake air pressure 622 and engine speed 344. Each function may include an appropriate algorithm that determine the rate of change of a parameter, for example, by calculating a derivative of the parameter and then comparing the rate of change to a predetermined threshold. When the absolute value of the rate is greater than the absolute value of the threshold, a flag 630 and 632 respectively may change from a first value, such as 1 that indicates that the engine is operating in a quasi-steady state, to a second value, such as zero, which indicates that a transient condition in the air pressure or engine speed has been detected. In this way, changes in intake air pressure 622 and/or engine speed 344 may be detected and may be taken as an indication that the operation of the engine is no longer quasi-steady for purposes of regeneration.

The engine speed 344, along with the engine fueling rate 346, is provided to a lookup table or map 634. The map 634 may be populated with digital values, for example zero or one, for each operating condition of the engine, as determined based on the engine speed 344 and engine fueling rate 346, where regeneration is permitted. A regeneration indicator flag 636 provided at the output of the map 634, which represents a value of one when regeneration is permitted and a value of zero when regeneration is not permitted. The regeneration indicator flag 636 is determined in real time based on the engine speed and fueling rate inputs 344 and 346 to the map 634. In a similar fashion, a lookup table 638 is disposed to receive the soot loading determination signal 310 and provide a soot loading flag 640 at its output that is active or equal to a first value, for example, a value of 1, when the soot loading determination signal 310 is indicative of sufficient soot loading to warrant regeneration, or equal to a second value, for example, zero, when the soot loading is not yet sufficient to warrant regeneration. The threshold soot loading for HSR may be set higher than a corresponding threshold for LSR events. In the illustrated embodiment, HSR events may be initiated when the soot loading of the DPF is already at 80% full relative to its total capacity, or higher. In the illustrated embodiment, the thresholds are provided by the HSR soot level trigger 602 described above.

The transient flags 630 and 632, the regeneration indicator flag 636 and the soot loading flag 640 are provided to an AND gate 642. In this way, the absence of transient changes coupled with the coincidence of enabling conditions can provide a positive or active state at an output 644 of the AND gate 642, provided some additional inputs to the gate 642 are also present. As shown in FIG. 10, additional flags that may be used as inputs to the AND gate 642 include the LSR window indicator 342, which inverted such that it is active when no conditions favorable for LSR are present, the regeneration readiness signal 350, which is configured to be active when HSR is desired, the regeneration active flag 624, which is inverted such that it is active when no regeneration is currently underway, and others. Thus, when the output 644 is active, it is an indication that HSR events may be initiated.

### INDUSTRIAL APPLICABILITY

The various block diagrams presented and described herein are directed to one embodiment of a control strategy for initiating a regeneration event for a DPF in accordance with the disclosure. Such control strategy may be implemented in the form of computer executable instructions that reside in a computer readable or accessible medium that is integrated with a logic device in a machine, such as an electronic controller. In the exemplary embodiment, the control strategy includes a determination of the soot loading of the DPF, a determination of the transient state of various engine or machine parameters, as well as a determination of the frequency and likelihood of conditions favorable for regeneration being present. This latter determination includes learning or adaptive functions that although prefer to initiate regeneration during non-work modes of the machine, will nevertheless initiate regeneration during quasi-steady state machine conditions during a work-mode. Factors influencing the initiation of work-mode regenerations include the frequency of non-work mode opportunities that are observed and/or recorded, and the existence of quasi-steady periods of machine operation during a work-mode in which HSR events may be completed.

It will be appreciated that the foregoing description provides examples of the disclosed system and technique for regeneration of a diesel particulate filter. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated. Moreover, all methods described herein can be performed in any suitable order unless otherwise indicated herein or otherwise clearly contradicted by context.

We claim:

1. A machine having an exhaust-treatment system that includes a diesel particulate filter (DPF) requiring periodic regeneration, the DPF disposed to receive a flow of exhaust gas provided by an engine associated with the machine, the machine comprising:
a sensor providing a soot signal indicative of a soot accumulation in the DPF;
at least one device providing an operating parameter indicative of a work mode of the machine;
a controller associated with the machine and disposed to receive the soot signal from the sensor and the operating parameter from the at least one device, the controller being further disposed to:
determine a soot loading of the DPF based at least partially on the soot signal;
determine a readiness level based at least partially on the operating parameter;
determine a soot level trigger based on a time period since a regeneration was completed and the readiness level; and
determine a debounce time period based on the soot loading and the readiness level;
wherein the controller is configured to initiate a regeneration event of the DPF when the debounce time period has expired while the soot loading exceeds the soot level trigger.

2. The machine of claim 1, wherein the determination of the soot level trigger is further based on a number of low speed regeneration (LSR) opportunities, each of which is determined based on the readiness level and recorded in the controller.

3. The machine of claim 1, wherein the determination of the debounce time period is further based on a number of low speed regeneration (LSR) opportunities, each of which is determined based on the readiness level and recorded in the controller.

4. The machine of claim 1, wherein the controller is configured to initiate a low speed regeneration (LSR) when the readiness level indicates that the machine is in a non-work mode, and a high speed regeneration (HSR) when the readiness level is above a threshold value indicative that the machine is in a work mode.

5. The machine of claim 4, wherein the controller is configured to initiate a LSR when the soot loading of the DPF is above a LSR soot trigger value, wherein the controller is configured to initiate a HSR when the soot loading of the DPF is above a HSR soot level trigger, and wherein the HSR soot level trigger is larger than the LSR soot level trigger.

6. The machine of claim 1, wherein the controller is configured to reduce the debounce time period when the readiness level is indicative that the machine is not in a work mode.

7. The machine of claim 1, wherein the controller is further configured to initiate a high speed regeneration (HSR) event when signals indicative of engine speed and engine load are in a quasi-steady state, when regeneration at a particular level of engine speed and engine load is allowable based on a predetermined relationship, and when the soot loading of the DPF is at least equal to the soot level trigger.

8. A method for initiating a regeneration event for a diesel particulate filter (DPF) associated with a machine and disposed to receive a flow of exhaust gas from an engine of the machine, the machine including a controller configured to selectively initiate a regeneration event of the DPF, the method comprising:
determining a soot loading of the DPF based at least partially on the soot signal;
determining a readiness level based at least partially on the operating parameter;
determine a soot level trigger based on a time period since a regeneration was completed and the readiness level; and
determining a debounce time period based on the soot loading and the readiness level;
wherein the controller is configured to initiate a regeneration event of the DPF when the debounce time period has expired while the soot loading exceeds the soot level trigger.

9. The method of claim 8, wherein determining of the soot level trigger is further based on a number of low speed regeneration (LSR) opportunities, each of which is determined based on the readiness level and recorded in the controller.

10. The method of claim 8, wherein the determination of the debounce time period is further based on a number of low speed regeneration (LSR) opportunities, each of which is determined based on the readiness level and recorded in the controller.

11. The method of claim 8, further comprising initiating a low speed regeneration (LSR) when the readiness level indicates that the machine is in a non-work mode, and a high speed regeneration (HSR) when the readiness level is above a threshold value indicative that the machine is in a work mode.

12. The method of claim 11, further comprising initiating a LSR when the soot loading of the DPF is above a LSR soot trigger value, and initiating a HSR when the soot loading of the DPF is above a HSR soot level trigger, wherein the HSR soot level trigger is larger than the LSR soot level trigger.

13. The method of claim 8, further comprising reducing the debounce time period when the readiness level is high, which is indicative that the machine is in a non-work mode or that the machine is operating in a quasi-steady state.

14. The method of claim 8, further comprising initiating a high speed regeneration (HSR) event when signals indicative of engine speed and engine load are in a quasi-steady state, when regeneration at a particular level of engine speed and engine load is allowable based on a predetermined relationship, and when the soot loading of the DPF is at least equal to the soot level trigger.

15. An after-treatment system associated with an engine of a machine, the after-treatment system comprising:
an after-treatment device disposed in fluid communication with an exhaust conduit that is connected to the engine;
a regeneration device disposed along the exhaust conduit between the engine and the after-treatment device;
a first sensor associated with the after-treatment device and disposed to provide a soot signal indicative of a soot accumulation in the after-treatment device;
a second sensor associated with the machine and disposed to provide a work signal indicative of a work mode of the machine;
a controller associated with the engine, the regeneration device, the first sensor, and the second sensor, the controller comprising at least one programmable processing unit and disposed to:
determine a soot loading of the DPF based at least partially on the soot signal;
determine a readiness level based at least partially on the operating parameter;
determine a soot level trigger based on a time period since a regeneration was completed and the readiness level;
determine a debounce time period based on the soot loading and the readiness level; and
command the regeneration device to initiate the regeneration event in the after-treatment device when the debounce time period has expired while the soot loading exceeds the soot level trigger.

16. The after-treatment system of claim 15, wherein the determination of the soot level trigger and the determination of the debounce time period are further based on a number of low speed regeneration (LSR) opportunities, each of which is determined based on the readiness level and recorded in the controller.

17. The after-treatment system of claim 15, wherein the controller is configured to initiate a low speed regeneration (LSR) when the readiness level indicates that the machine is in a non-work mode, and a high speed regeneration (HSR) when the readiness level is above a threshold value indicative that the machine is in a work mode.

18. The after-treatment system of claim 17, wherein the controller is configured to initiate a LSR when the soot loading of the DPF is above a LSR soot trigger value, wherein the controller is configured to initiate a HSR when the soot loading of the DPF is above a HSR soot level trigger, and wherein the HSR soot level trigger is larger than the LSR soot level trigger.

19. The after-treatment system of claim 15, wherein the controller is configured to reduce the debounce time period when the readiness level is indicative that the machine is not in a work mode.

20. The after-treatment system of claim 15, wherein the controller is further configured to initiate a high speed regeneration (HSR) event when signals indicative of engine speed and engine load are in a quasi-steady state, when regeneration at a particular level of engine speed and engine load is allowable based on a predetermined relationship, and when the soot loading of the DPF is at least equal to the soot level trigger.
